(19) United States
(12) Patent Application Publication
(10) Pub. No.: US 2006/0023457 A1
(43) Pub. Date: Feb. 2, 2006

(54) Luminaire utilizing reflecting and refracting optics

(76) Inventor: Kevin F. Leadford, Evergreen, CO (US)

Correspondence Address: CLARK & BRODY, 1090 VERMONT AVENUE, NW, SUITE 250, WASHINGTON, DC, 20005, US

(21) Appl. No.: 11/171,383

(22) Filed: Jul. 1, 2005

Related U.S. Application Data
(60) Provisional application No. 60/585,841, filed on Jul. 8, 2004.

(51) Int. Cl. F21V 7/00

(52) U.S. Cl. 362/297; 362/308; 362/328; 362/346

(57) ABSTRACT

Optical arrangements particularly useful with reflector/refractor combinations to direct light in a defined pattern with a minimum of stray light place the illumination sources as closely as possible to the reflectors. In a preferred embodiment the invention is embodied in an emergency luminaire mounting multiple lamps within a single optical cavity. In a preferred embodiment, two lamps are mounted in fixed positions within a single optical chamber relative to reflective surfaces configured according to the invention to generate light that directly impinges on a refractive lens fitted over a luminaire aperture or is reflected by the reflective surfaces through said refractive lens to distribute light over desired portions of an egress path or the like. The invention further includes the method of designing luminaires and, in particular, in configuring the reflectors of such luminaires.

### TECHNICAL FIELD

The invention relates generally to luminaires for providing a desired light pattern with minimum stray light and, particularly, to luminaires having a reflector cooperating with a refractor to produce a well-defined beam of light. In another aspect, the invention relates to a method of designing a luminaire system to accommodate a specified aperture.

### BACKGROUND ART

Luminaires used in a variety of environments suffer from inadequacies arising from the inability to control stray light. Stray light is undesirable because it reduces efficiency to the target and also can result in either glare or the unwanted illumination of restricted areas, e.g., another's property. In particular, improvements are desirable in luminaires that use both reflecting and refracting components to direct light into a well-defined beam. Such luminaires may be floodlights, or the like, and a particular luminaire of this kind is known as a “unit emergency” lighting fixture. Unit emergency luminaires are employed to illuminate environmental spaces during emergencies, and such luminaires typically operate on battery power on loss of mains power when usual lighting levels cannot be maintained. Unit emergency luminaires conventionally employ two independent optical systems. These prior art optical systems can either be fixed or configured for independent movement relative to each other and relative to a housing of the luminaire. “Fixed optic” lamp/reflector combinations are usually configured such that each lamp/reflector combination directs light over a given separate area, the direction of light from each combination being determined during design of the luminaire. “Movable optic” lamp/reflector combinations can be manually adjusted after mounting the luminaire to the support structure so that light from each of the movable combinations can be adjusted as desired to illuminate a particular area. The two, lamp/reflector combinations of such unit luminaires are often referred to as “frog eyes.”

Unit emergency luminaires are commonly employed for illumination of egress paths and the like, while similar luminaires provide both a “night light,” through the use of a light emitting diode, and an emergency light, through use of a separate light source operable on emergency power. Luminaires intended for such purposes ordinarily employ relatively small, low wattage lamps, typically incandescent lamps, for the emergency lighting because the levels of illumination required are low. It is known to use two lamps for the emergency lighting to provide redundancy and increase reliability. The loss of one such lamp, as through burnout, can result in a light distribution similar to that provided by both of the lamps, but the overall illumination is reduced. One such luminaire is marketed by the Lithonia Lighting Group of Acuity Brands, Inc., Atlanta, Ga., and is shown in U.S. Pat. No. D468,046 to Bernard et al.

The luminaire shown in U.S. Pat. No. D468,046 is typically provided with two lamps arranged vertically within a single optical cavity and spaced from a reflector, which reflects light through a clear, unpatterned lens covering the output aperture of the cavity. This luminaire, referred to commercially as a “safety light,” is intended primarily for residential use as a nightlight. A light emitting diode is the source for the nightlight and is ordinarily operable on mains power. The emergency light is provided by two incandescent lamps that operate on self-contained battery power on failure of mains power.

One difficulty associated with known arrangements, such as that used in the prior luminaire, is that for any point in the output aperture the angle between light rays arriving at the output aperture directly from the lamp and those that have been reflected can be large. In a typical arrangement using a parabolic reflector with the light source at the focal point, the light incident on the output aperture directly from the source is typically on the order of 25%-30% of the total flux. This means that a significant portion of the flux comes directly from the light source while the remainder is reflected and arrives at the aperture collimated, resulting in a large angular distribution of the incident rays. Moreover, the angle between the direct and reflected rays is larger for points in the aperture further away from the axis.

It is very difficult, if not highly impractical, to design a refracting element capable of receiving rays of such large angular distributions and still providing the desired light pattern. This is particularly so when the lens is of the type formed by a large number of small prisms, because providing all light rays from a single direction allows each prism to more effectively control the light distribution. Controlling distribution of the light onto the illuminated area is a primary objective of beam-forming luminaires, as in the present invention. Beam forming requires the predetermined placement of light, as opposed to simply projecting a diffuse and essentially random distribution of light into the illuminated area.

Accordingly, prior luminaries using both reflecting and refracting optical elements require improvements that reduce stray light and provide a desired light distribution pattern.

### SUMMARY OF THE INVENTION

In accordance with one aspect of the invention, a unique approach is followed in the design of a luminaire resulting in an improved distribution of light with reduced glare. In the design approach of the invention, a reflector for a luminaire of the type using the reflector and a refractor is considered to comprise two parts. These two parts are configured to provide output rays of reduced angular divergence at a predetermined output aperture. This approach finds particular utility in the design of a luminaire having a prismatic refractor to provide the desired light pattern from light passing through the output aperture of the reflector.

The first part of the reflector comprises those elements that lie generally in front of the light source, and the second part comprises those elements that lie generally behind the light source. The elements of the first part generally extend from the forward part of the light source to the output aperture and are designed primarily to reflect light rays emanating from the source toward the aperture efficiently and in directions close to the directions of other rays arriving at the same cross-sectional element of the aperture. That is, the reflector elements are designed to reflect the rays such that the angular divergence of all rays in the given cross-sectional element is minimized. This facilitates design of the respective prismatic element and decreases stray light.

The front part of the reflector may take virtually any shape. Where the output aperture is polygonal, it is convenient to provide the front part as a plurality of planar, triangular elements. As used herein, it is understood that “triangular” includes truncated triangular shapes.

The second, rear part of the reflector is configured to reflect light rays from the rear of the light source back toward the aperture. In accordance with another aspect of this invention, the configuration of the rear part of the reflector and the relative positioning of the light source with respect to the rear part are such that the rear part of the reflector generates an image of the light source coincident with the physical light source or closely adjacent to it. This achieves the important objective of maintaining the source and its images close to each other. Placing the image of the light source close to the light source itself reduces the geometric extent of the source and the images of the source. Lighting engineers are generally concerned with the location of the “point of regard,” which is the geometric center of the source and its images, for each point of view in the output aperture of the luminaire. Arranging the reflective surfaces to reduce the geometric extent of the light source and its images, simplifies the design process by reducing variations in the location of the point of regard for different points of view and tends to make the actual light pattern in practice closer to the desired pattern.

A basic goal of the invention is to group the light source and its images as closely together as possible. The lamp and its images created by the rear reflector are located as close as possible to the reflectors of the first part to ensure that all of the images of the light source, e.g., those created both by the front part of the reflector and those created by the rear part of the reflector, are grouped closely together with the physical source. This facilitates defining the location of the point of regard for the various points of view through the aperture and simplifies design.

The invention provides multiple-lamp luminaires in preferred embodiments capable of directing a particular light distribution onto an area such as an egress pathway. In the preferred embodiment the light source includes two lamps, and a desired light distribution is maintained even on burn out of one of the lamps. The luminaires contemplated according to the invention typically have a single optical cavity with fixed lamping disposed within the cavity, it not being possible to reorient or redirect light distribution from any one of the lamps once assembled and placed for operation in a location intended to be illuminated. The luminaires of the invention also generally take the form of emergency luminaries, which function on loss of mains power during emergency conditions, the luminaires typically being powered in the emergency mode by self-contained battery power. In one embodiment, a luminaire configured according to the invention comprises an optical chamber having a shaped reflector disposed in close proximity to one or more illumination sources located in an optical cavity, such illumination sources typically taking the form of low-wattage incandescent lamps. The illumination sources are positioned effectively to “touch” the shaped reflector and define points of regard for the prismatic elements of a lens disposed over an aperture of the optical chamber, the prismatic lens directing light into a desired light pattern.

In a preferred embodiment, the lamps have elongated, substantially linear filaments that lie substantially on the cylindrical axis of a cylindrical reflector. The cylindrical reflector is the rear part of the luminaire reflector and reflects light from the filaments directly back onto the filaments to form images of the filaments coincident with the filaments themselves. Some light sources, such as HID lamps, are sensitive to reentrant flux. In embodiments utilizing such sources, the rear reflector is designed to place the image of the source closely adjacent the lamp, but not coincident with it. The reflector in this case may be the involute of a cylinder (or that of a sphere, depending on the shape of the light source) instead of the cylindrical reflector used with lamps having incandescent filaments.

A particular reflector configured according to one embodiment of the invention comprises a reflector as described above wherein the front part is made up of an assembly of planar segments extending from the output aperture to the center of the luminous part of the light source.

In operation, the luminaires of the invention provide a particularly directed illumination level over an area such as an egress pathway in an emergency mode, this mode being activated on failure of mains power to respond to a need to illuminate egress pathways within an environmental space such as a commercial building. The luminaires of this embodiment of the invention are provided with two lamps, these lamps being of relatively low wattage. In the event of loss of illumination from one of the lamps, such as on burn out, the emergency luminaires of the invention are configured to maintain a given light distribution over a predetermined critical zone at a lower illumination level. Zones requiring particularly directed illumination of this kind are typically egress paths such as must be illuminated during emergency conditions as are usually accompanied by loss of mains power. Industry standards for emergency egress path illumination require particular illumination of a three-foot wide strip down the center of a hallway having a nominal width of six feet. Within such environments, illumination of an average of one foot-candle, a minimum of 0.1 foot-candle and a maximum-to-minimum ratio not exceeding 40:1 is necessary. Luminaires configured according to the invention meet or exceed these industry standards.

The invention further contemplates provision of an optical cavity having a fixed lamp or fixed multiple lamps within the cavity and capable of use with luminaire external geometries of pleasing configuration. A particular configuration according to the invention has a generally arcuate lens element covering the luminaire aperture, the lens having prisms formed thereon for directing light as desired to at least a portion of an emergency egress path, for example, and for also obscuring lamp and lamp images in order to provide a more attractive luminaire. The performance of the present luminaire is also of critical importance due to the necessity of using as few of the luminaires as possible for illumination of a given area, such as a given length of an egress pathway.

The invention also encompasses luminaires having an illumination source providing light which is to be advantageously directed by at least one reflector having a reflective region immediately “behind” the illumination source and closely spaced from the source, the illumination source and its reflected image essentially forming a “point source”, a “line source”, etc., with the reflective region being shaped to accommodate the illumination source and to efficiently direct light to a lens or the like disposed over a luminaire aperture, the lens functioning as a refractive element in preferred embodiments. Luminaires so configured according to the invention are capable of use in a variety of lighting environments and can be designed to have shaped apertures of varying conformation.

Accordingly, a primary object of the invention is to provide luminaires capable of producing well-defined beams of light having a predetermined distribution with minimal stray light, the luminaires having at least one reflector configured to conform to geometries of light sources which are closely spaced from regions of the reflector shaped to accommodate said sources, the reflector preferably being used with a refractive element to provide a desired lighting distribution.

A particular object of the invention is to provide an improved fixed-optic luminaire having multiple lamps located within a single cavity optical chamber and configured to direct light to predetermined locations at a given level of illumination, light distributions remaining consistent even with failure of one of the lamps.

A still further object of the invention is to provide a reflector configuration comprising two parts, wherein one part reflects light from a lamp to form an image of the light source close to or coincident with the lamp and the second part reflects light to an output aperture with minimum divergence between rays arriving at any small segment of the aperture.

Yet another object of the invention is to provide a new method of designing a luminaire, the method including the design of an appropriate reflector configuration that is at least in part dictated by the particular shape of the luminaire's output aperture.

Further objects and advantages of the invention will become more readily apparent in light of the following detailed description of the preferred embodiments.

### BRIEF DESCRIPTION OF THE DRAWINGS

FIG. 1 is an idealized perspective view of a reflector configured according to an embodiment of the invention and having a light source illustrated in an assembly arrangement prior to mounting of the light source in an operable relation to the reflector;

FIG. 2 is an idealized perspective view of a reflector configured according to another embodiment of the invention;

FIG. 3 is an idealized perspective view of a reflector configured according to yet another embodiment of the invention;

FIG. 4 is a schematic illustrating location of a point of regard in an idealized arrangement of a reflector and a light source of a particular shape;

FIG. 5 is a perspective view of a prior art emergency lighting luminaire having an unpatterned lens spaced from an aperture of the luminaire to illustrate an optical chamber of the luminaire;

FIG. 6 is a perspective view of an emergency luminaire configured according to the invention and shown with a prismatic lens spaced from an aperture of the luminaire to illustrate details of an optical chamber of the luminaire;

FIG. 7 is an exploded view of the optics of the present invention;

FIG. 8 is an exploded view of the optics of the present emergency luminaire shown with the reflective portions of said optics being assembled together and with a prismatic lens shown spaced therefrom in order to better illustrate the configuration of the reflective portions of the optics;

FIG. 9A is a front perspective view of a primary reflector configured according to the invention;

FIG. 9B is a perspective view similar to the view of FIG. 9A but with lamping removed in order to illustrate particular structure;

FIG. 9C is a bottom view of the reflector of FIG. 9A;

FIG. 9D is a detail view of a portion of the reflector of FIG. 9C with portions of the reflector removed for ease of illustration;

FIG. 9E is a perspective view of the reflector;

FIG. 10A is a perspective view of a substantially planar reflector configured according to the invention;

FIG. 10B is a side elevation view of the reflector of FIG. 10A;

FIG. 11 is a cross-sectional view of an optical chamber defined by the several optical elements of the invention and shown partially cut away to illustrate details of the optical chamber;

FIG. 12A is a front view of a refractive lens configured according to the invention;

FIG. 12B is a side elevation view of the lens of FIG. 12A;

FIG. 12C is a cross-sectional view taken along lines C-C of FIG. 12B;

FIG. 13A is a perspective view of an actuating element utilized in the luminaires of the invention for test and self-diagnostic functions; and,

FIG. 13B is a perspective view of the actuator of FIG. 13A shown with associated structure forming a portion of a luminaire housing and electronics contained within said housing.

FIG. 14 is a schematic illustrating a reflected ray for a gas discharge lamp.

### DETAILED DESCRIPTION OF THE PREFERRED EMBODIMENTS

Referring now to the drawings, FIG. 1 shows an optical arrangement configured according to the invention, the optical arrangement comprising a reflector 2 having an essentially square output aperture, such as could be utilized in a floodlight luminaire, or the like. The reflector 2 comprises two parts. One part lies in front of the luminous part of the light source 4 and forms the output aperture, and the second part lies behind the luminous part of the light source. Lamp 4 is shown in an exploded assembly relation to the reflector 2, the lamp 4 essentially comprising either a filament or gaseous discharge tube, which in the embodiment shown is generally cylindrical. The rear part 3 is cylindrical so that the lamp 4 can be located as closely as possible to the surfaces of the reflector 2 and to the rear part 3. The reflective surfaces of the rear part 3 may either comprise facets or be a smoothly arcuate surface.

The rear part 3 is configured to reflect light from the lamp 4 toward the aperture by forming an image of the luminous source on or near to the luminous source. If the lamp is of the type that is not sensitive to reentrant flux, such as an incandescent source, the objective is to form an image of the filament coincident with the filament itself. Thus, if the lamp is incandescent and presents essentially a point source, the reflective surfaces of the rear part 3 would be spherical. If it were linear, the rear part 3 would be cylindrical. On the other hand, if the light source is sensitive to reentrant flux, the rear part 3 is configured to place the image closely adjacent the source, but not coincident with it. The reflector 2 is to be used in association with a refractor (not shown) as will be appreciated from a consideration of the embodiment discussed below to produce the optical result described herein.

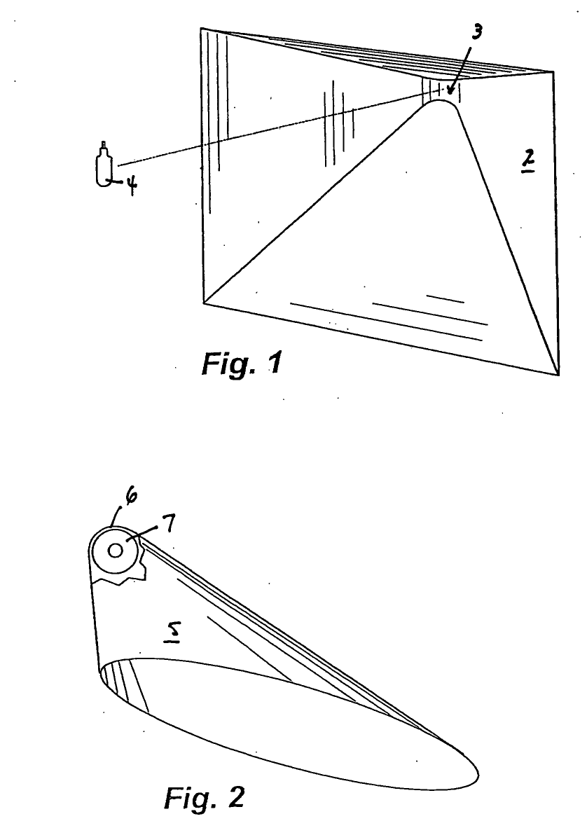

FIG. 2 illustrates a reflector 5 having a different shape. The reflector 5 is designed to fit an elliptical output aperture transverse to an axis of symmetry of the reflector such that the rear part 6 is eccentric. In this situation, an essentially spherical lamp 7 may be disposed as closely as possible to the spherical surface of the rear part 6, a filament of the lamp 7 comprising a light source which in this embodiment effectively comprises a point source. The reflective surfaces of the rear part 6 can be faceted or smoothly continuous. The shape of the reflector 5 illustrates the ability to conform a reflector to a variety of aperture geometries while retaining the optical characteristics intended according to the invention. The reflector 5 produces the results intended according to the invention through combination with a refractor (not shown) as is described and shown herein with reference to other reflector geometries.

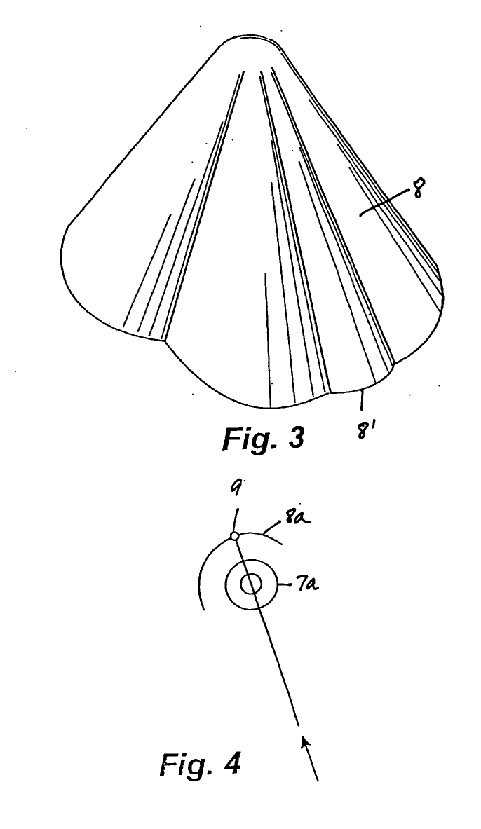

FIG. 3 illustrates a reflector 8 wherein the rear part is essentially spherical with the front part comprising reflective surfaces angled relative to each other. The reflector 8 has an aperture in the shape of an irregular “polygon” with arcuate edges. The reflector 8 may be used according to the principles of the invention with a point source lamp and a refractor as is shown and described herein relative to other reflector geometries.

The reflectors seen in FIGS. 1 through 3, as well as others to be disclosed below, are particularly intended for use with refractors. In configuring a refractor for use with the reflectors disclosed herein, a point of regard is chosen for directing light generated by the illumination source and reflected by the reflective surfaces of the rear part of the reflector. The point of regard is a theoretical location in the geometric center of the collection of illuminating “objects,” that is, the lamp filaments, arcs and/or flashed images. The location of the point of regard may change as a function of the point of view of a particular segment of the surfaces of a refractor being constructed as well as on the nature of the reflector. When an illumination source is a point source, and the lamp is imaged onto itself, the center of the source is conveniently used. When a linear or cylindrical source 7a is used, as illustrated schematically in FIG. 4, that point on cylindrical reflective surfaces 8a that is directly behind an arc of the reflective surfaces is chosen, this point being illustrated at 9 with the arrow indicating the point of view. In a dimension perpendicular to the plane of FIG. 4, alignment with the center of the illumination source 7a is desired. As such, the point of regard differs for each prism of a refractor so devised. When complex reflector geometries are required, the point of regard can be chosen as the lamp center or a point on the rear reflector to simplify refractor design.

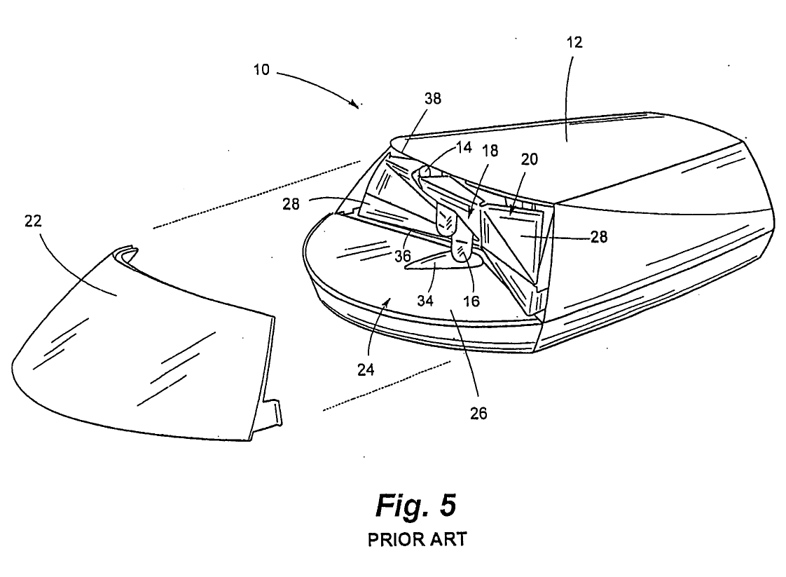

Referring now to FIG. 5, a prior art luminaire designed and marketed by the assignee of the present invention is seen at 10 to comprise a luminaire housing 12 that is similar to housings used in preferred embodiments of the present invention, the prior art luminaire 10 being intended for use in residential environments to provide illumination helpful in the sense of a “night light” but which is capable on failure of mains power to operate on self-contained battery power to continue the “night light” function even to the extent of facilitating egress from inhabited spaces in the event of emergencies as can involve power failures. The prior art luminaire 10 utilizes two lamps 14 and 16 arranged in a “front-to-back” relationship with the lamp 14 being located adjacent a portion 18 of a complex reflector 20, the lamp 16 being located inwardly of the location of the lamp 14 and “stepped down” from the lamp 14. Two lamps are utilized in the prior art luminaire 10 to provide redundancy in the event of failure of either one of the lamps 14, 16 so that illumination of a useful degree will continue. The prior art luminaire 10 will provide a useful light distribution with only one of the lamps 14, 16 that is similar to the light distribution provided on operation of both of the lamps 14, 16. The particular lamp arrangement and the reflective capabilities of the prior art luminaire 10, especially when considered in light of the use therein of a simple diffusing lens 22, does not provide the improved light distribution resulting from application of the principles of the invention.

The prior art luminaire 10 is further seen to mount the lamps 14, 16 within a single optical cavity shown essentially at 24, said cavity 24 being enclosed and defined by the reflector 20, the diffusing lens 22 and a planar reflector 26. It is understood that the optical cavity 24 is configured according to a geometry occasioned by a preselected aesthetic shape of the luminaire housing 12 of the prior art luminaire 10, the diffusing lens 22 being also configured in view of such aesthetic considerations as well as other requirements imposed on the design of the luminaire 10. Given the operational necessities associated with the use of the prior art luminaire 10, it is to be understood that the diffusing lens 22 need only be formed of a substantially light transmissive material such as a polycarbonate which is “frosted” in order to obscure the lamps, the lens 22 not functioning in any realistic manner to direct light emanating from the optical cavity 24 onto particular areas. The complex reflector 20 is formed of reflector segments 28, which may be shaped by bending a sheet of reflective material commonly used in the manufacture of reflective structures. The general configuration of the complex reflector 20 is arcuate about an aperture 30 formed therein through which the lamps 14, 16 extend from a mounting by a lamp holder (not shown). A dimple 34 in the planar reflector 26 accommodates the distal end of the lamp 16. The complex reflector 20 comprises six reflector segments 28, with three of the segments being disposed on either lateral side of the lamps 14, 16, each of the segments 28 being angled relative to adjacent segments with outward segments at each end of the complex reflector 20 effectively contacting the planar reflector 26 at respective inner edges 36. Outer edge 38 of the planar reflector 26 is arcuately shaped in order to conform to a desired shape of the prior art luminaire 10. It is to be particularly noted that the innermost segments 28 directly adjacent the lamps 14, 16 on either side thereof are essentially coplanar, that is, the two innermost segments 28 forming a dihedral angle that is only slightly less than 180°.

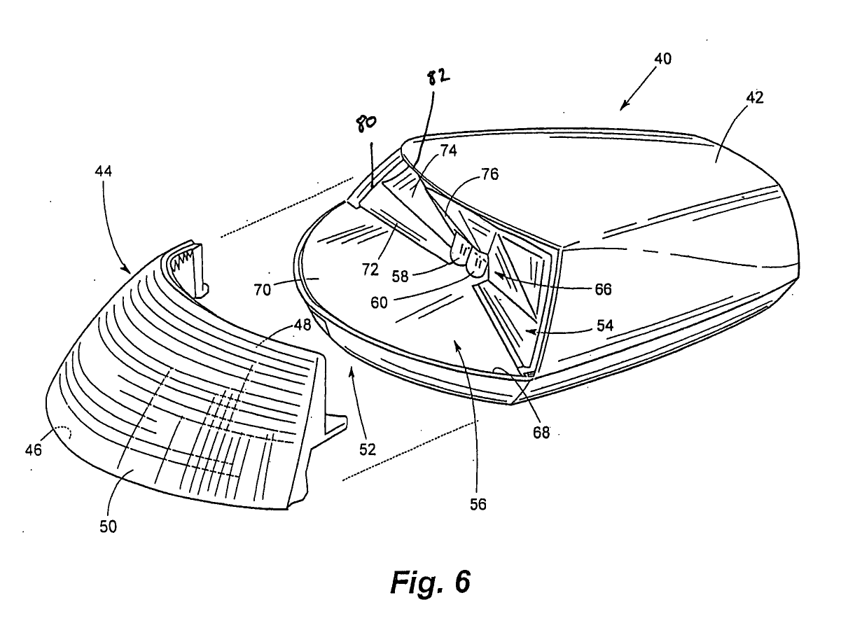

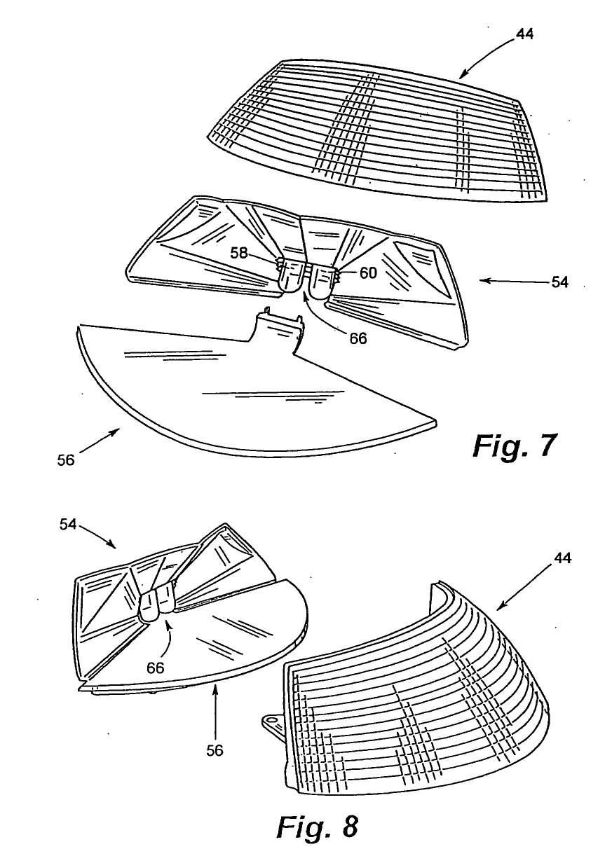

Referring now to the remaining drawings and particularly to FIGS. 6 through 8, a preferred embodiment of a luminaire 40 comprises a housing 42 similar in design concept to the housing 12 of the prior art luminaire 10 described herein, the housing 42, as well as the prior art luminaire housing 12, having a distinctive appearance as is disclosed and claimed in U.S. Pat. No. D468,046. Housing configurations other than that shown herein can be used to advantage through application of the present inventive concept. Optical cavities of unusual shape, reflector geometries, lens configurations and lamp placements of differing description are practical given the present teachings.

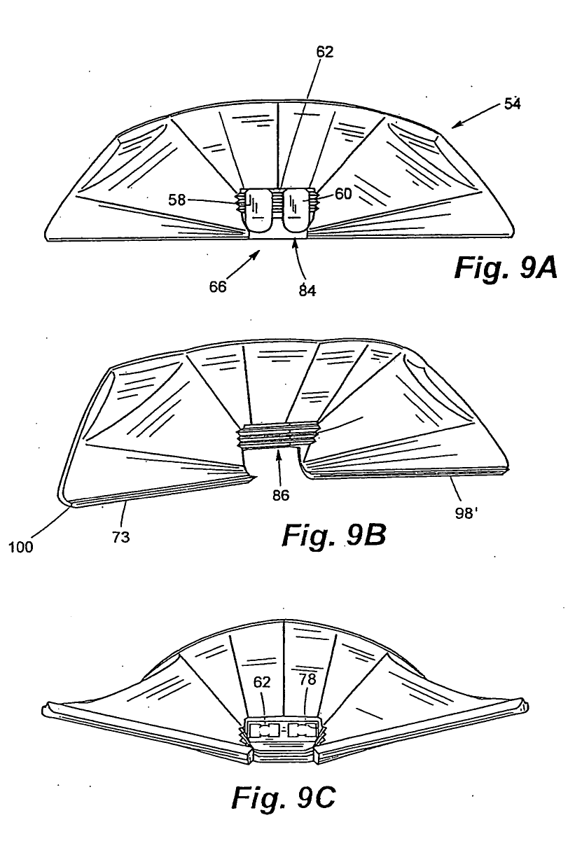

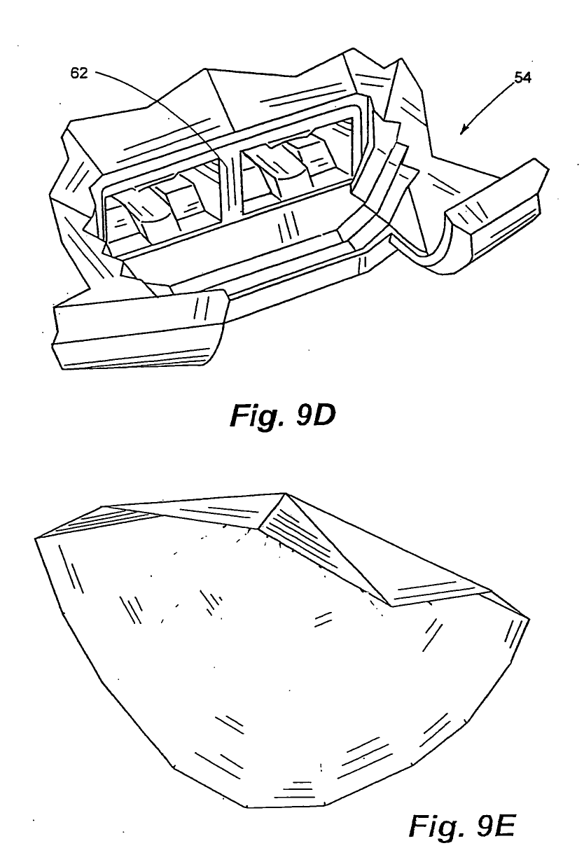

The luminaire 40 includes a refractive lens 44 having, in the embodiment shown, arcuate shape to match the output aperture of the luminaire. The lens 44 comprises a plurality of refractive prisms 46, preferably disposed on the inner surface 48. The outer surface 50 of the lens 44 is preferably smooth for easily maintaining the surface clean for maximum light output from the luminaire 40. The lens 44 partially defines an optical cavity seen generally at 52, which is further defined by a part that lies in front of the luminous source and a rear part 66, which lies behind the luminous source. In the embodiment shown, the reflector comprises a plurality of planar reflecting surfaces, which include a number of smaller surfaces 54 and a larger reflector 56. This particular configuration conveniently matches the shape of the output aperture, and it will be appreciated that other arrangements of planar surfaces are possible and, further, that other output apertures will require other arrangements of planar and/or curved surfaces. A lamp holder 62 (see also FIGS. 9c and 9d) mounts two lamps 58 and 60 within the optical cavity 52. The lamps 58, 60 are disposed side-by-side such that the linear filaments of the lamps are aligned. (The filaments may not be strictly linear but may be considered that for purposes of the invention.) The lamps are also disposed as close to the rear reflecting part 66 of the reflector 54 as possible to locate the actual light sources, that is, the lamp filaments (not expressly shown) as close to the reflective surface 66 as possible. This provides a more compact collection of the light sources and their images to define better a point or points of regard for the prisms 46. Even though multiple lamp images are present due to the use of multiple lamps 58 and 60, the lamp images are close to the rear reflector 66 regardless of the point of view in the aperture.

The front reflective structure is formed of individual reflective segments 70, 72, 74 and 76, the segment 70 being the larger reflector 56 with the segments 72 being the outwardly disposed reflective surfaces of the smaller reflective surfaces 54. In the embodiment shown, all of these surfaces are planar and conceptually form the front part of the reflector as described in connection with FIGS. 1-3. For manufacturing purposes only, the front part of the reflector is made in the two pieces shown. The segments 74 are inwardly disposed from the segments 72 while the segments 76 are the most inwardly disposed reflective surfaces of the reflector 54. The segments 72, 74, and 76 are substantially triangular although apices thereof are removed to form aperture 78 (see FIG. 9C) of the complex reflector 54 at and in the vicinity of the rear reflector 66, the aperture 78 being necessary for mounting of the lamps 58, 60. The segment 70 and, thus, the planar reflector 56 is essentially pie-shaped with lateral edges 80 and an arcuate edge 82. Lateral edges of the segments 72 of the complex reflector 54 are each disposed along and preferably in contact with the respective edges 80 of the segment 70 of the reflector 56. The lamps 58, 60 as aforesaid, are located between the front and rear parts just in front of the rear part 66. Arranging the lamps 58, 60 side-by-side allows the reflector 54 and the refractive lens 44 to distribute the light along an egress path to be illuminated by the luminaire 40. The lamp placement shown as well as the configuration of the optics of the luminaire 40 acts to collect light from the lamps 58, 60 and from lamp images thereof that will be broad in a horizontal or sidewise dimension relative to the luminaire 40 and narrow in a vertical dimension, thereby providing particularly effective illumination of an elongated surface such as an egress path or the like.

The lamps 58 and 60 are preferably Xenon lamps, such as T3¼ wedge-based lamps of 5.4 watts as are manufactured by Benshine, such lamps having a filament oriented substantially perpendicular to the axis of the lamp, such filaments being typically shaped in an arc. With such lamping, a usual expedient is to provide an opening in the reflector 54 near the rear 66 thereof for insertion of the bases of such lamps. Since the teachings of the present concepts contemplate placement of lamp filaments as near to the reflective surfaces as possible, it is therefore desirable to prevent passage of light through openings and out of the optical cavity 52 to the degree possible. The lamps 58, 60 are therefore located as shown with lamp bases protruding through an upper portion of the reflector portion 54 at 84 to be spaced from the rear of the luminaire 40, that is, away from a wall (not shown) on which a rear face of the luminaire 40 would be mounted in use. If the rear part were an apex near the position of the lamp filaments, a relatively large percentage of the generated light would be trapped in the apex itself, the light necessarily reflecting multiple times before passing out of the luminaire 40 with much light being lost to absorption. Thus, in accordance with one principle of the invention, light from the source is imaged back on the source (or close to it) to increase light output. lable 88

Preferably reflector portion 86 is configured such that, to the degree possible, light will be reflected only once while maintaining the images of the lamp filaments near the actual filaments. The reflector portion 86 is, therefore, shaped to effectively conform to luminous portions of the lamps 58, 60 and to preferably have reflecting ridges 88 extending laterally thereacross to prevent light from reflecting through the aperture 78, the reflected light instead being redirected toward filaments of the lamps 58, 60. The reflector portion 86 is contiguous with arcuate reflector portion 87 to produce an unbroken reflective surface, which reflects light striking the reflector portion 86 and the reflector portion 87 in the direction of the lamp filaments. In the case of incandescent lamps, the reflector 87 is cylindrical with the filaments lying on the cylindrical axis of reflector 87. In the case of a gas-discharge lamp or other source sensitive to reentrant flux, the reflector is the involute of a cylinder, as described above, whereby the image is adjacent the lamp. The configuration of the apex reflector portion 86 with the ridges 88 prevents trapping of light. The ridges 88 essentially function as a Fresnel structure. The optical cavity 52 formed by assembly of the reflectors 54 and 56 relative to the lamps 44 is seen in FIG. 11, the assembly being shown in section for purposes of illustration.

Referring also now to FIGS. 9A through 9E, the complex reflector 54 is seen in detail to be formable of a material capable of being bent from a metal sheet or the like, having a highly specular finish disposed over the reflective segments 70, 72, 74, 75 and 76. The segments are angled with respect to each other to reflect light to the aperture at small angles to the direct light from the source for each point of view. Surfaces of the segments can be formed other than as planar segments. Edges of the reflectors 54 and 98 may have elongated flanges such as that shown at 100 formed therealong, the flanges 100 essentially abutting opposing surfaces of a reflector along the edges thereof to form a light seal therealong on assembly of the reflectors. These segments may also be formed as a single piece.

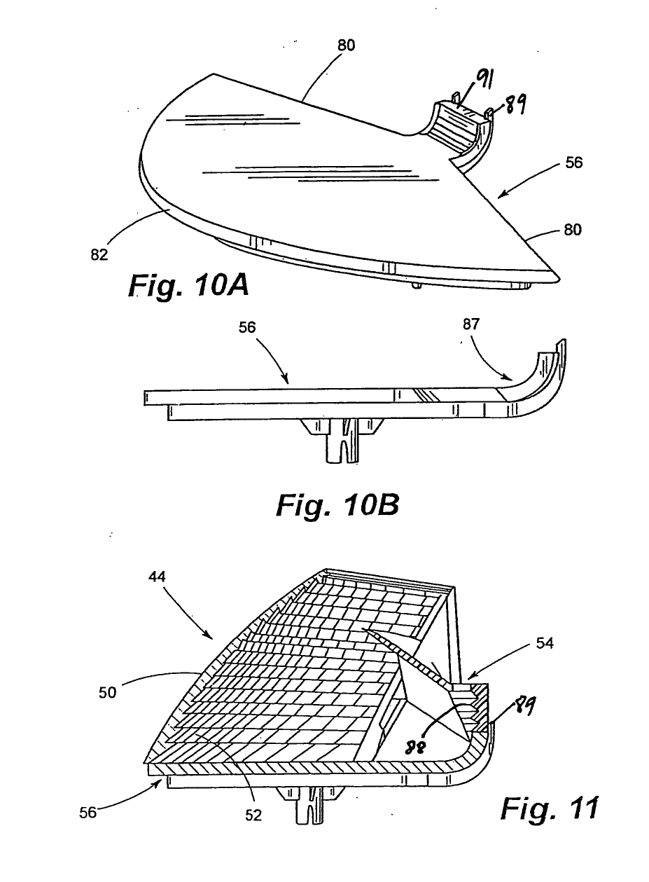

FIGS. 10A and 10B illustrate a preferred application of the principles of the invention to the particular luminaire shown in FIG. 6. The larger reflector segment 56 of the front part is molded with a cylindrical rear reflector portion 87 to form a single element. This arrangement has been done only for ease of manufacture and is not required to accomplish the purposes of the invention. The segment 56 and the rear reflector portion 87 are arranged such that when placed in the housing 42, the lamps will be positioned with respect to the reflector portion 87 so that it will image the light source on itself or closely adjacent as descried above.

The primary purpose of the reflective segments of the front and rear parts is to group all of the lamp images near the lamp to present a compact collection of lamps and lamp images to the output aperture. Lateral edges of the reflector portion 87 mate with similarly shaped edges of the reflector portion 86. The reflector portion 87 and the reflector portion 86 provide reflective surfaces located immediately behind the lamps 58, 60. The reflector portion 87 may include projections 89 that extend over edge 91 to positively locate the reflector portion 87 relative to the reflector portion 86.

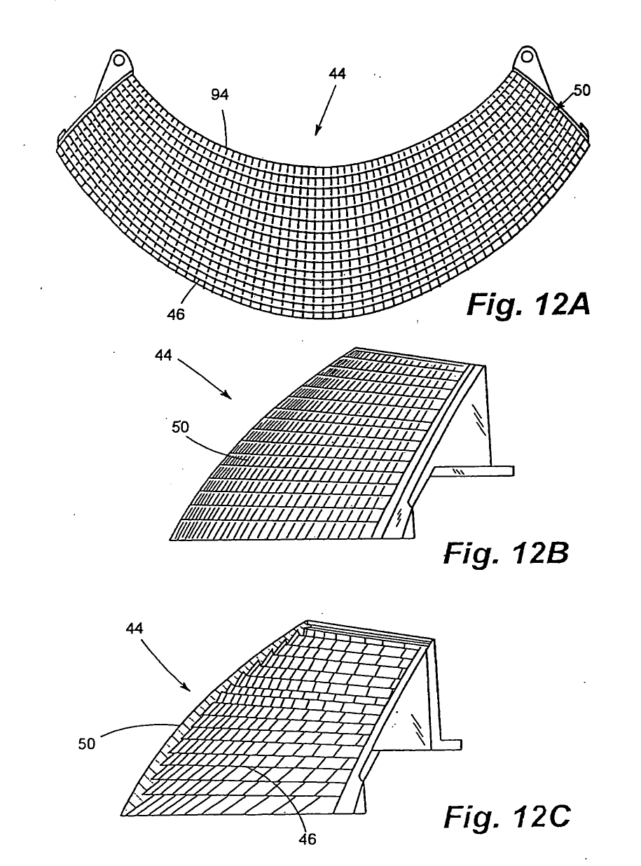

Referring now to FIGS. 12A through 12C, the refractive lens 44 is seen in detail to be configured in a manner capable of directing both the light emanating directly from the lamps 58, 60 and the light reflected by the reflective surfaces of the reflectors 54, 56 along an elongated path of egress or the like. The refractive lens 44 also functions to obscure optical cavity 52 from view. The prisms 46 function in concert with the reflectors 54, 56 to accomplish the light distributional function intended. While the scale of the prisms 46 is relatively unimportant in terms of light distribution, scale does impart appearance and the ability to obscure the optical cavity 52 to the desired degree. In a preferred embodiment, each of the prisms 46 is formed essentially as a square prism approximately 0.1 inch on each side. A grid is employed to establish nodes 94, such a grid being superimposed over the outer surface 50 of the lens 44 in a 16×64 array as viewed from the front of the lens 44 according to a preferred embodiment. A centerpoint can thus be calculated between four adjacent nodes 94 and, since each of the prisms 46 is formed of planar faces, light can only be redirected by each of the prisms 46 in a single direction. A point-to-point correspondence between each prism center and its contribution point on a path of egress (not shown) that is to be illuminated can be established, that is, the 16×64 array of points, that is, centers, is established so that each of the prisms 46 will aim to a respective contribution point on a path of egress or the like. The line from a point on the egress path to the prism center point on the lens 44 is thus established and refraction at the outer surface 50 of the lens 44 can be calculated to determine the direction of light traveled within the lens 44, thereby permitting according to known principles the determination of the pitch required on the inner surface 48 to work back to the point of regard, that is, the center of lamp filaments and filament images, to establish the geometry of the lens 44.

It is to be appreciated that the number of reflected lamp images seen from exteriorly of the luminaire 40 varies depending on the point of view through the aperture 78, an indication that certain of the prisms 46 affect a greater percentage of light than do others of the prisms 46. Further, the angular separation of the lamps 58, 60 and lamp images differ, thereby resulting in differing beam spreads from each of the prisms 46. Choosing an appropriate distribution of points along an egress path or other surface that is to be illuminated accounts for beam spread differences. In view of the fact that beam smoothness is relatively unimportant in the use environment of the luminaire 40, it is possible to aim all of the prisms 46 along a line down the center of the path of egress to maximize the average light level. The points along the centerline of the path of egress are laid out exponentially so as to be spaced closer together at more distant throws, thereby permitting illumination levels to be relatively constant along the centerline of the egress path or other area being illuminated.

Although not shown in the drawings, the housing 42 is configured internally to contain a battery, a circuit board, etc., the circuit board having operational circuitry formed thereon with leads that connect to the lamp holder 62 as well as to the battery so that emergency power can be supplied to operate the lamps 58, 60 as required. On burn-out of either of the lamps 58, 60, the remaining lamp provides an essentially identical light distribution particularly directed onto a surface such as a path of egress through the agency of the optical structure provided by the luminaire 40. Snap fittings located on mating portions of the housing 42 function to hold the portions of the housing together, said portions being further secured in a conventional manner, such as by screws or other fasteners.

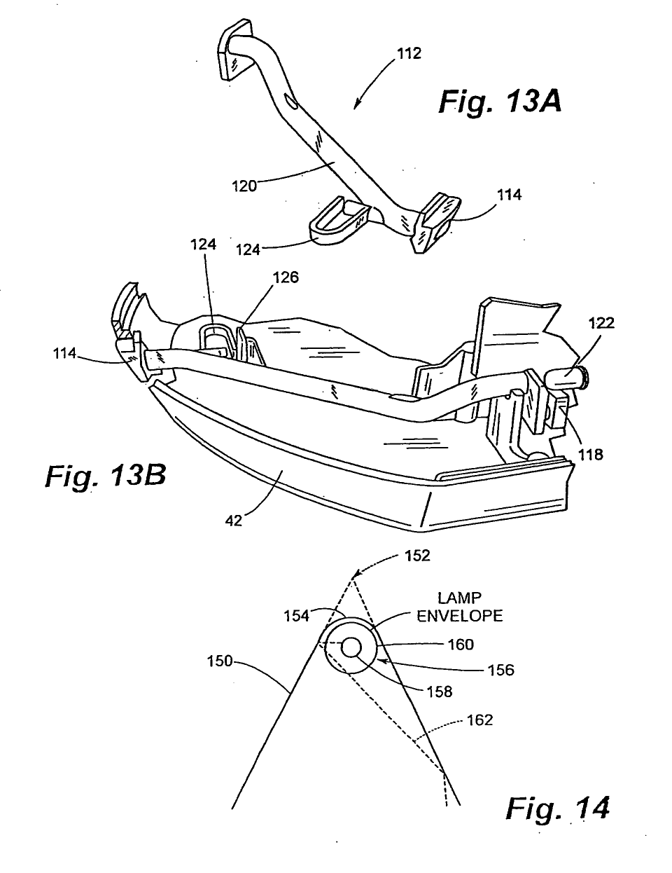

Referring now to FIGS. 13A and 13B, a light pipe actuator 112 is seen to be formed of a thumb switch 114 located in an aperture 115 formed in the housing 42, the thumb switch 114 being depressed manually from externally of the luminaire 40 to actuate a switch 118 carried by a circuit board 119 contained within the housing 42 to provide a test and/or self-diagnostic function. The actuator 112 further comprises an elongated body 120 that carries light from an LED 122 mounted on the printed circuit board to the thumb switch 114 for viewing of the light produced by the LED 122. Resiliency of the actuator 112 is provided by an integral spring element 124 that biases against a stop 126 mounted to the housing 42 interiorly thereof, the spring element 124 acting to return the actuator 112 to a depressible position on release of thumb pressure on the thumb switch 1 14. The light pipe actuator 112 is formed essentially entirely of a light transmitting material which allows light to move through the actuator 112 from the LED 122 to the thumb switch 1 14 to be visible from exteriorly of the luminaire 40. lable 115 119

Referring now to FIG. 14, a generalized schematic illustrates a forward portion 150 of the reflector, which may be a single curved surface or a plurality of planar segments, depending on the particular shape of the luminaire aperture. For a circular aperture, the reflector is preferably a cone. For a polygonal aperture, the reflector segments are typically triangles. In this example, if the sides of the reflector portion 150 were extended as illustrated by the dashed lines, they would intersect at 152. If the reflector were to have that configuration, the light from the rear part of the lamps could become trapped or reflected at uncontrolled angles. In accordance with the invention, the reflector is configured to provide a rear reflector 154 to image the light source onto itself or closely adjacent, as described above. This allows the lamp 156 to be placed as close as possible to the rear reflective part 154. One principle of the invention is to locate the lamp filament, such as filament 158, as close as possible to the reflective surfaces. In practice, however, the lamp 156 has a glass envelope 160, which inherently spaces the filament 158 from said inner reflective surfaces. Thus, the rear part of the reflector is shaped to image the light source onto itself.

Ray trace 162 illustrates the formation of an image of the light source by the front part of the reflector. Because the lamp is as close as possible to the reflector 150, the image of the lamp formed by the reflector 154 will be close to the lamp itself.

In accordance with a method according to the invention, a luminaire reflector is configured for any given luminaire by first constructing the front part of the reflector to match the output aperture at one end and to converge toward each other at the other end. The segments must also accommodate other structural restrictions, such as the shape of the housing. As noted earlier, if the output aperture comprises a three-dimensional array of points connected by lines, (e.g., polygonal if the points are coplanar), the front part of the reflector is generally designed to comprise a plurality of converging triangular, planar segments. If the aperture is circular, the reflector may be conical. Then, the position of the rear part of the reflector is determined by the location of the smallest cross section of the converging segments that can accommodate the lamp. The position of the luminous part of the lamp when the lamp is located at the smallest cross section possible determines the boundary between the front part of the reflector and the rear part. The rear part of the reflector is then designed to match the cross section of the rear part and either to image the luminous source on itself or closely adjacent to it as described above. The method of determining the location of the rear part can also be visualized as “dropping” the lamp into the front part of the reflector with the aperture facing upward and then replacing the parts of the reflector below the lamp with a reflector that images the lamp onto or close to itself. It is also desirable to locate the rear part on a line intersecting the geometric center of the output aperture and extending opposite the direction of the major part of the light distribution and, also, to make the front part of the reflector as deep as possible to collimate the beam. By following these steps, the designer will be able to locate the luminous source and its images as close to the reflectors as possible.

It is to be understood that the invention can be practiced other than as explicitly described herein without departing from the scope of the invention as defined by the appended claims. In practice of the invention, it is to be noted that lamps have a filament geometry and a glass envelope geometry, the geometry of the filaments being that aspect of a lamp that is of importance optically. The geometry of the glass envelope is of consequence essentially only to the degree that the envelope prevents a given lamp from being disposed as closely to reflector surfaces as would be desired theoretically in the absence of such an envelope. Reference herein to lamping is therefore intended to refer to a filament thereof in the optical sense or to the glass envelope in the mechanical sense.

What is claimed is:

1. A luminaire comprising means for supporting a light source and a reflector, wherein the reflector comprises a first reflective portion comprising a reflecting surface for directing light from said light source or its images toward an output aperture, and a second reflective portion positioned behind the luminous part of the light source and configured to form an image of said light source coincident with or closely adjacent the light source.

2. A luminaire according to claim 1 further comprising a refracting lens covering said aperture and directing light incident thereon into a desired pattern.

3. A luminaire according to claim 2 wherein said refracting lens comprises a plurality of small prisms.

4. A luminaire according to claim 2 wherein said second reflective portion is cylindrical, and said means for supporting is configured to support a lamp having a substantially linear filament such that the filament is substantially coincident with the cylindrical axis of said second reflective portion.

5. A luminaire according to claim 2 wherein said first reflective portion is spherical, and said means for supporting is configured to support a lamp having an essentially point-source filament coincident with the center of curvature of said first reflective portion.

6. A luminaire according to claim 1 wherein said aperture is polygonal and said first reflective portion comprises a plurality of substantially planar reflecting segments.

7. A luminaire according to claim 6 wherein said segments are triangular.

8. A luminaire according to claim 1 wherein said aperture is circular and said first reflective portion is conical.

9. A method for designing a luminaire comprising the steps of:
a. defining the shape of an output aperture;
b. defining a reflector comprising a three-dimensional configuration having the shape of said aperture at one end and converging toward an opposed end;
c. determining the location of a cross section of said reflector substantially the size of a desired lamp having a luminous source; and
d. defining a rear part of said reflector that will image said luminous source substantially onto itself or closely adjacent thereto when said lamp is located at said cross section.

10. A method according to claim 9 wherein said rear part of said reflector images said luminous source substantially onto itself.

11. A method according to claim 10 wherein said rear part is cylindrical.

12. A method according to claim 9 wherein said rear part is an involute.

13. A method according to claim 9 wherein said aperture is formed by a plurality of points connected by lines, and said reflector comprises a plurality of planar segments.

14. A method according to claim 9 wherein said aperture is circular and said reflector is conical.

15. A method according to claim 9 further comprising the step of locating the rear part such that it lies on a line intersecting the geometric center of the output aperture and extends opposite the direction of the major part of the light distribution.
